(19) United States
(12) Patent Application Publication
(10) Pub. No.: US 2012/0303157 A1
(43) Pub. Date: Nov. 29, 2012

(54) REJECTION OF DEFECTIVE VEGETABLE WITH SCATTERING AND REFRACTING LIGHT

(76) Inventor: Jing-Yau Chung, Houston, TX (US)

(21) Appl. No.: 13/512,116

(22) PCT Filed: Nov. 23, 2010
(86) PCT No.: PCT/US2010/057767

§ 371 Date: May 25, 2012

Related U.S. Application Data
(60) Provisional application No. 61/264,524, filed on Nov. 25, 2009.

(51) Int. Cl. B07C 5/34; G06F 7/00

(52) U.S. Cl. 700/223; 209/577

(57) ABSTRACT

A defective vegetable rejecting device, including methodology, has a transparent of semi-transparent conveyor, a set of light sources mounted offset from a centerline of the conveyor, light blocking plates mounted proximate and aligned with the light source and the conveyor, a light receiver mounted on a side of the conveyor opposite from the light source; and nozzles for rejecting a defective vegetable.

### CROSS-REFERENCE TO RELATED APPLICATIONS

This application claims the benefit of U.S. Provisional Application No. 61/264,524 filed 25 Nov. 2009.

### BACKGROUND

Insects infest vegetables in spite of efforts to control or resist insects in the field. Additionally, vegetables can appear or be less than desirable for presentation to consumers for a variety of other reasons, e.g., mold, fungus, decay, etc. Food processing plant inspection line workers are charged with the task of removing or rejecting defective vegetables which may, for example, be infested by insects. However, worker eyes, etc. are subject to fatigue and limitations of the human eye such that defective vegetables may mistakenly pass through the inspection process.

### SUMMARY

In a vegetable (collectively referring to all leafy vegetable, flower vegetable, root vegetable and beans etc.) processing plant, it is highly desirable to have an effective means of sorting out the individual vegetable that has been defective e.g. the bean pod is infested with an insect (collectively referring to an adult insect and a worm), a bean pod has been discolored, broken or too small in size. In the case of the insect infested vegetable, in many cases such insect is hidden inside the vegetable and is not visible by eye-inspection from the appearance of the vegetable. In addition to sorting out defective vegetables of the other kinds mentioned above, the current embodiment of the invention uses a new method of making e.g. the insect inside the vegetable to become visible using eye-inspection or electronic means by means of infrared or visible light scattered and refracted from the subject vegetable. In the case of using electronic means, computer software is used to identify the defective objects automatically. A new method is used to continuously discard the individual defective vegetable or a small portion of the vegetable which includes the infested vegetable. An optional image enhancement technique is employed to enhance the visibility of the insect in the infested vegetable.

### BRIEF DESCRIPTION OF THE SEVERAL VIEWS OF THE DRAWINGS

FIG. 1 is a front elevation view of one embodiment of a defective vegetable rejecting device

FIG. 2 is a side view of the embodiment shown in FIG. 1.

FIG. 3 is a top view of an embodiment of a zoning plate as shown in FIGS. 1 & 2.

FIG. 4 is a top view showing vegetables on a conveyor belt.

### DETAILED DESCRIPTION OF THE PREFERRED EMBODIMENT(S)

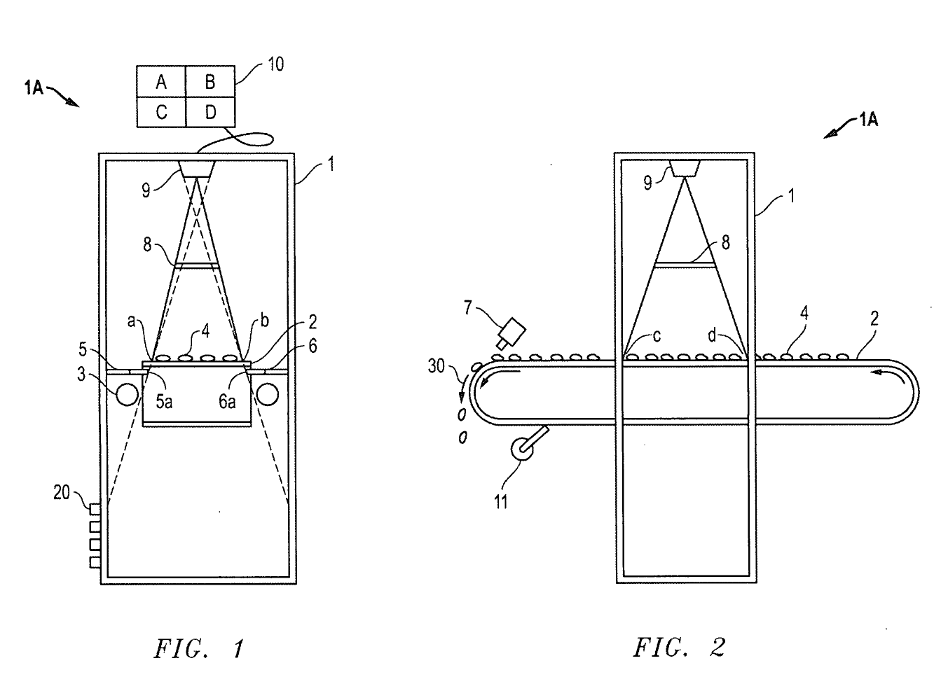

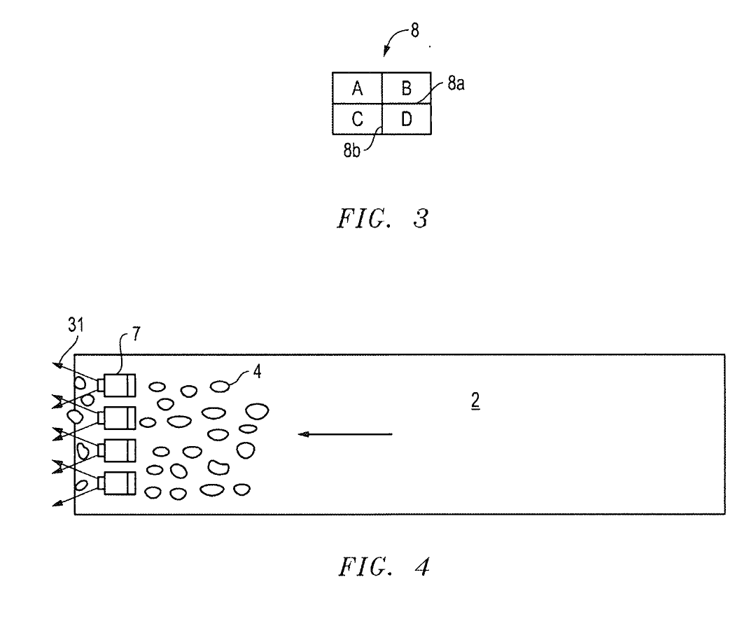

One embodiment of a defective vegetable rejecting device 1A is shown in FIGS. 1-4. This embodiment of the defective vegetable rejecting device 1A generally has a main frame 1, a conveyor (e.g. conveyor belt) 2, light source(s) 3 (preferably but not necessarily at least one set of light source(s) 3 mounted offset from a centerline of the conveyor 2), a light receiver or a video camera 9, a monitor 10, a set of pressurized air or water (or other substance) nozzle(s) 7, light-blocking plates 5 and 6 and a zoning plate 8 with, by way of example only, partitioning line 8a and line 8b (which is orthogonal to line 8a in the embodiment shown) which define zones or regions A, B, C and D as depicted in FIG. 3. FIG. 2 shows the side view of the defective vegetable rejecting device 1A. Also shown in FIG. 1 are a set of triggering buttons 20. Each button is designated to trigger a specific nozzle 7 shown in FIG. 4 for injecting high pressure air or water at the directions referenced or depicted by arrows 31 to shoot at and to discard the vegetable within a designated zone A, B, C and/or D on the conveyor 2.

As mentioned, the zoning plate 8 shown is by way of example only. The zoning plate 8 could be partitioned such that there are more or less zones than the four zones A, B, C, D shown. The zoning plate 8 could be partitioned such that the zones than A, B, C, D are smaller or larger. The zoning plate 8 could be partitioned such that the zones are defined by shapes or configurations other than the rectangular zones A, B, C, D shown. The zoning plate 8 should however be transparent for transmitting the image of the moving objects 4 on the conveyor 2. The transmitted image can be analyzed either by eye inspection or by computer software. In the case of analyzing the image by computer software, the zoning plate 8 is optional and can be eliminated. In this case the computer software detects the defective vegetable directly from the image recorded by the camera 9.

With reference to FIGS. 1 and 2, the conveyor belt 2 carries vegetable 4 on the conveyor belt passing through the mid section of the frame 1 just above the opening between the respective edges 5a and 6a of light-blocking plates 5 and 6. The conveyor belt 2 is transparent or semi-transparent (e.g. an off-the-shelf transparent or semi-transparent conveyor belt 2) such that the light emitted from light source(s) 3 can pass through the conveyor belt without a significant attenuation. The light-blocking plates 5 and 6 block the light while allowing the light to pass through the opening between the edges 5a and 6a. As shown in FIG. 1, only the light scattered and refracted from the subject vegetable 4 as well as the conveyor belt 2 between spatial boundaries (depicted by lines a and b in FIG. 1) and between spatial junctures (depicted by lines c and d in FIG. 2) is seen by the light receiver or video camera 9. A transparent or glass plate 8 preferably having at least two partitioning lines 8a and 8b is placed between the receiver 9 and the subject 4 (which in the embodiment shown is a vegetable) such that, on image (displayed on monitor 10) of the receiver 9, the entire view of the subject section of the conveyor 2 conveying vegetables is concurrently partitioned into multiple zones e.g. zones A, B, C and D as depicted in FIG. 3. The infrared is digitized and converted to visible light to display the subject vegetable on a monitor 10. In the case of using a visible light source, the video camera brings the subject image on the monitor 10. When the human operator or the computer software detector finds a defective vegetable within or at a specific zone, say zone A, the operator pushes the designated button 20 to trigger the designated nozzle 7, such that a portion of the vegetables containing the defective vegetable in zone A is discarded from the conveyor belt 2 by means of a high pressure air jet or water jet from nozzle(s) 7 which blows the defective vegetable in the direction 31 as depicted in FIG. 4 such that the defective vegetable is blown away from its normal dropping trajectory referenced by arrow 30 as depicted in FIG. 2. In the case of automation, a specific nozzle 7 may be triggered by, for example, electronic means to perform the rejection described above after the computer software detects the defective vegetable. It should be noted; the partitions A, B, C, and D can be generalized to be small partitions with each partition containing only one or a few subject vegetable(s). With the precision, the goal would be to reject only one vegetable that being the defective vegetable, whilst retaining all of the remaining desirable vegetables on the conveyor 2.

Referring to FIG. 2, a conveyor cleaning device 11 is used to clean the conveyor belt 2 constantly to assure a clear view of the vegetable received by the light receiver or video camera 9. The position of various components of the system could be reversed such that the light source(s) 3 are mounted above the conveyor 2 while the receiver 9 is mounted below the conveyor 2. In the case of a vegetable 4 of greater density, the vegetables may be guided into non-overlapping moving lines for clearly and easier detections. Such non-overlapping moving lines can be obtained by using a shaker system (not shown) with straight channels in which the vegetable is conveyed or using a set of equally spaced dividers (not shown) to guide the vegetable into non-overlapping moving lines.

What is claimed is:

1. An apparatus for rejecting a defective vegetable, comprising:
a conveyor selected from the group consisting of a transparent conveyor and a semi-transparent conveyor;
at least one light source mounted offset from a centerline of the conveyor;
at least two light blocking plates mounted proximate and aligned with the light source and the conveyor;
a light receiver mounted on a side of the conveyor opposite from the light source; and
a means for rejecting a defective vegetable.

2. The apparatus according to claim 1, further including a transparent zoning plate mounted proximate the conveyor on a side opposite from the light source and interposed with the light source and the light receiver.

3. The apparatus according to claim 2 wherein the transparent zoning plate includes at least one partition line.

4. The apparatus according to claim 2 wherein the transparent zoning plate includes two partition lines orthogonal to each other.

5. The apparatus according to claim 1, wherein the light receiver is a video camera.

6. The apparatus according to claim 5, further including a monitor in communication with the video camera.

7. The apparatus according to claim 1, wherein the light source is mounted below the conveyor.

8. The apparatus according to claim 1, wherein the light source comprises a set of light sources.

9. The apparatus according to claim 1, wherein the means for rejecting a defective vegetable comprises a nozzle dispensing a volume of a substance under pressure.

10. The apparatus according to claim 9, wherein the means for rejecting the defective vegetable further comprises a computer software analysis of an image in communication with and resulting from the light receiver.

11. The apparatus according to claim 1, further comprising a conveyor cleaner mounted proximate the conveyor.

12. An apparatus for rejecting a defective vegetable, comprising:
a conveyor selected from the group consisting of a transparent conveyor and a semi-transparent conveyor;
at least one set of light sources mounted offset from a centerline of the conveyor;
at least two light blocking plates mounted proximate and aligned with the set of light sources and the conveyor;
a light receiver mounted on a side of the conveyor opposite from the light source;
a transparent zoning plate mounted proximate the conveyor on a side opposite from the light source and interposed with the light source and the light receiver;
wherein the transparent zoning plate includes two partition lines orthogonal to each other;
a monitor in communication with the light receiver; and
a means for rejecting a defective vegetable.

13. A method for rejecting a defective vegetable in a processing plant, comprising the steps of:
conveying a vegetable product;
lighting the vegetable product while conveying;
refracting the light;
determining a location of a defective vegetable by receiving the refracted light; and
rejecting the defective vegetable.

14. The method according to claim 13, wherein said step of determining the location of the defective vegetable comprises the steps of:
partitioning the lighted vegetable product into multiple zones;
displaying the refracted light with is received; and
inspecting the vegetable product by viewing the display.

15. The method according to claim 13, wherein said step of lighting the vegetable product comprises lighting from below the vegetable product; and wherein said step of receiving the refracted light comprise receiving from above the vegetable product.

16. The method according to claim 13, further including the step of blocking a portion of the light between spatial boundaries.

17. The method according to claim 13, wherein said step of determining the location of the defective vegetable comprises the steps of inspecting the vegetable product by analyzing an image using computer software.
